(19) United States
(12) Patent Application Publication
(10) Pub. No.: US 2026/0358499 A1
(43) Pub. Date: Nov. 12, 2026

(54) APPARATUS AND METHOD FOR NOISE FILTERING OF LIDAR SENSOR

(71) Applicant: HL Klemove Corp., Incheon (KR)

(72) Inventor: Hyeong-Jun JOO, Incheon (KR)

(73) Assignee: HL Klemove Corp., Incheon (KR)

(21) Appl. No.: 19/538,473

(22) Filed: Feb. 12, 2026

(30) Foreign Application Priority Data
May 9, 2025 (KR) 10-2025-0060374

(51) Int. Cl. G01S 17/42; G01S 7/481; G01S 17/86

(52) U.S. Cl. CPC G01S 17/42; G01S 7/4817; G01S 17/86

(57) ABSTRACT

The present disclosure relates to an apparatus and a method for noise filtering of a LiDAR sensor, and provides an apparatus including one or more processors and a memory storing one or more programs executable by the one or more processors, wherein the one or more processors determine environmental information of a location in which the LiDAR sensor is located using sensing data acquired from the LiDAR sensor, and dynamically set a filtering threshold for removing noise from the sensing data based on the environmental information, and the apparatus and the method may be applied to other embodiments as well.

### CROSS-REFERENCE TO RELATED APPLICATION

The present application claims priority under 35 U.S.C. § 119(a) to Korean patent application number 10-2025-0060374 filed on May 9, 2025, in the Korean Intellectual Property Office, the entire disclosure of which is incorporated by reference herein.

### BACKGROUND

### 1. Technical Field

The present disclosure relates to an apparatus and a method for noise filtering of a LiDAR sensor.

### 2. Related Art

A LiDAR (light detection and ranging) sensor is a sensor that detects an object by emitting light and receiving a signal reflected from the object, and calculates a distance to the object by measuring a time between a transmitted signal and a received signal. Since such a LiDAR sensor is capable of acquiring a point cloud based on accurate distance information compared to a camera, the LiDAR sensor is used as an essential sensor, particularly in vehicles, autonomous driving robots, and the like.

The LiDAR sensor is mainly mounted at a front of a vehicle or an autonomous driving robot and exposed to an outside in order to improve sensing performance. The LiDAR sensor has a relatively higher object detection probability and distance accuracy compared to a camera. However, since the LiDAR sensor is affected by an external environment, such as weather and illuminance, and thus an intensity of a received signal decreases, there is a problem in that distance detection accuracy and object detection accuracy of the LiDAR sensor are degraded depending on environmental conditions.

Accordingly, there is a growing need for a technology capable of recognizing an environment being sensed by a LiDAR sensor and improving detection accuracy of the LiDAR sensor according to the environment.

### SUMMARY

In order to solve the above-described problems of the related art, embodiments of the present disclosure are directed to providing an apparatus and a method for noise filtering of a LiDAR sensor, which are capable of recognizing environmental information in which the LiDAR sensor operates and dynamically setting a noise filtering threshold of the LiDAR sensor based on the recognized environmental information, so as to solve the conventional problems described above.

An apparatus for noise filtering of an LiDAR sensor according to an embodiment of the present disclosure may include one or more processors; and a memory storing one or more programs executable by the one or more processors, wherein the one or more processors may be configured to determine environmental information of a location in which a LiDAR sensor is located using sensing data acquired from the LiDAR sensor; and change a filtering threshold for removing noise from the sensing data based on the environmental information.

In addition, the one or more processors may be configured to determine an intensity value and an ambient value from the sensing data.

In addition, the one or more processors may be configured to determine the intensity value from the sensing data based on a wavelength of emitted light irradiated from the LiDAR sensor.

In addition, the one or more processors may be configured to determine the ambient value from the sensing data based on a wavelength of light other than the wavelength of the emitted light.

In addition, the one or more processors may be configured to determine a correlation coefficient between 0 and 1 based on the intensity value and the ambient value, and determine the environmental information based on the correlation coefficient.

In addition, the one or more processors may be configured to set the filtering threshold to be greater than a reference filtering threshold when the correlation coefficient is equal to or greater than 0.5.

In addition, the one or more processors may be configured to set the filtering threshold to be gradually increased as the correlation coefficient becomes closer to 1.

In addition, the one or more processors may be configured to set the filtering threshold to be equal to or smaller than the reference filtering threshold when the correlation coefficient is less than 0.5.

In addition, the one or more processors may be configured to set the filtering threshold to be gradually decreased as the correlation coefficient becomes closer to 0.

In addition, the one or more processors may be configured to remove the noise by deleting intensity values that are less than the dynamically set filtering threshold from the sensing data.

Furthermore, a method for noise filtering of an LiDAR sensor according to an embodiment of the present disclosure, the method performed by an apparatus comprising one or more processors and a memory storing one or more programs executable by the one or more processors, may include determining environmental information of a location in which a LiDAR sensor is located using sensing data acquired from the LiDAR sensor; and changing a filtering threshold for removing noise from the sensing data based on the environmental information.

In addition, the method may further include determining an intensity value and an ambient value from the sensing data.

In addition, the step of determining the intensity value may include determining the intensity value from the sensing data based on a wavelength of emitted light irradiated from the LiDAR sensor.

In addition, the step of determining the ambient value may include determining the ambient value from the sensing data based on a wavelength of light other than the wavelength of the emitted light.

In addition, the step of determining the environmental information may include determining a correlation coefficient between 0 and 1 based on the intensity value and the ambient value, and determining the environmental information based on the correlation coefficient.

In addition, the method may further include setting the filtering threshold to be greater than a reference filtering threshold when the correlation coefficient is equal to or greater than 0.5.

In addition, the step of setting the filtering threshold to be greater than the reference filtering threshold may include setting the filtering threshold to be gradually increased as the correlation coefficient becomes closer to 1.

In addition, the method may further include setting the filtering threshold to be smaller than a reference filtering threshold when the correlation coefficient is less than 0.5.

In addition, the step of setting the filtering threshold to be smaller than the reference filtering threshold may include setting the filtering threshold to be gradually decreased as the correlation coefficient becomes closer to 0.

In addition, the method may further include removing the noise by deleting intensity values that are less than the dynamically set filtering threshold from the sensing data.

As described above, an apparatus and method for noise filtering of a LiDAR sensor according to the present disclosure can improve reliability of sensing data acquired from the LiDAR sensor by recognizing environmental information in which the LiDAR sensor operates and dynamically setting a noise filtering threshold of the LiDAR sensor based on the recognized environmental information.

### BRIEF DESCRIPTION OF THE DRAWINGS

FIG. 1 is a block diagram schematically illustrating a main configuration of a noise filtering apparatus according to an exemplary embodiment of the present disclosure.

FIG. 2 is a flowchart for explaining a noise filtering method according to an exemplary embodiment of the present disclosure.

FIGS. 3A and 3B are exemplary screen views for explaining a method of classifying an environment using a correlation coefficient according to an exemplary embodiment of the present disclosure.

FIGS. 4A and 4B are exemplary screen views for explaining a method of dynamically setting a filtering threshold according to a classified environment according to an exemplary embodiment of the present disclosure.

### DETAILED DESCRIPTION OF THE EMBODIMENTS

Hereinafter, specific embodiments according to an embodiment of the present disclosure will be described with reference to the drawings. The following detailed description is provided to aid in a comprehensive understanding of the methods, apparatuses, and/or systems described herein. However, these are merely examples, and the present disclosure is not limited thereto.

In describing the embodiments of the present disclosure, detailed descriptions of related known technologies will be omitted when it is determined that such descriptions may unnecessarily obscure the gist of the embodiments. The terms described below are defined in consideration of the functions of the present disclosure and may vary depending on the intention or custom of the user or operator, or other practices. Therefore, the definitions of the terms should be interpreted based on the overall contents of this specification. The terminology used in the detailed description is intended merely to describe exemplary embodiments and should not be construed as limiting. Unless clearly stated otherwise, expressions in the singular form include the plural form as well. In the present description, expressions such as “comprise,” “include,” or “provide” are intended to indicate the presence of stated features, numbers, steps, operations, elements, components, or combinations thereof, and should not be interpreted as excluding the possibility of the presence or addition of one or more other features, numbers, steps, operations, elements, components, or combinations thereof. In addition, terms such as “unit,” “device,” “module,” and “block,” as used in the present specification, refer to functional elements configured to perform at least one function or operation and may be implemented in hardware, in software, or in a combination of hardware and software.

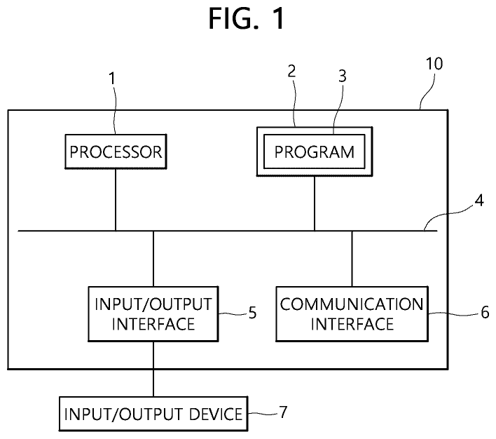

FIG. 1 is a block diagram schematically illustrating a main configuration of a noise filtering apparatus according to an exemplary embodiment of the present disclosure.

Referring to FIG. 1, an apparatus 10 according to the present disclosure may be a computing apparatus, such as an electronic device, capable of dynamically setting a filtering threshold for filtering noise from sensing data acquired from a LiDAR sensor, and the apparatus 10 may include a processor 1, a computer-readable storage medium 2, a program 3, a communication bus 4, an input/output interface 5, and a communication interface 6. The apparatus 10 may include one or more input/output devices 7 connected through the input/output interface 5.

The processor 1 may cause the apparatus 10 to operate according to exemplary embodiments described below. For example, the processor 1 may execute one or more programs 3 stored in the computer-readable storage medium 2. The one or more programs 3 may include one or more computer-executable instructions, and when executed by the processor 1, the computer-executable instructions may be configured to cause the apparatus 10 to perform operations according to the exemplary embodiments.

The communication bus 4 interconnects various components of the apparatus 10, including the processor 1, the computer-readable storage medium 2, the input/output interface 5, and the communication interface 6.

The apparatus 10 may include one or more input/output interfaces 5 that provide interfaces for one or more input/output devices 7, and one or more communication interfaces 6. The input/output interface 5 and the communication interface 6 are connected to the communication bus 4. The input/output device 7 may be connected to other components of the apparatus 10 through the input/output interface 5. Exemplary input/output devices 7 may include pointing devices (such as a mouse or a trackpad), a keyboard, touch input devices (such as a touchpad or a touchscreen), voice or sound input devices, various types of sensors including a LiDAR sensor and/or input devices such as cameras, and output devices such as a display device, a speaker, and a light. The input/output device 7 may be included inside the apparatus 10 as one component constituting the apparatus 10, or may be connected as a separate device from the apparatus 10.

More specifically, the processor 1 may receive, as sensing data, reflected light obtained when emitted light irradiated from a LiDAR sensor is reflected by an object, natural light, or reflected light obtained when natural light is reflected by an object. In this case, the sensing data may include various types of feature data including intensity and ambient. The processor 1 identifies an intensity value and an ambient value from the received sensing data.

The processor 1 identifies a wavelength of emitted light irradiated from the LiDAR sensor. The processor 1 identifies, as an intensity value, data having a wavelength corresponding to the wavelength of the emitted light from the sensing data. The processor 1 identifies, as an ambient value, data having a wavelength other than the wavelength of the emitted light from the sensing data, for example, data having a wavelength corresponding to natural light.

The processor 1 calculates a correlation coefficient between 0 and 1 based on the identified intensity value and ambient value. To this end, the processor 1 calculates a standard deviation of the ambient value and the intensity value, and a covariance between the ambient value and the intensity value, and calculates the correlation coefficient using the standard deviation and the covariance.

The processor 1 may determine that an environment is an outdoor or daytime environment when the calculated correlation coefficient is close to 1, and may determine that the environment is an indoor or nighttime environment when the correlation coefficient is close to 0.

The processor 1 sets a filtering threshold for removing noise from the sensing data. The processor 1 may set the filtering threshold to be greater than a preset reference filtering threshold when the calculated correlation coefficient is equal to or greater than a threshold, for example, 0.5, and may set the filtering threshold to be gradually increased as the correlation coefficient becomes closer to 1. In this case, the value 0.5 is set for convenience of description and is not necessarily limited thereto, and the reference filtering threshold may be a value preset based on the LiDAR sensor.

In addition, when the calculated correlation coefficient is less than 0.5, the processor 1 may set the filtering threshold to be equal to the reference filtering threshold or set the filtering threshold to be smaller than the reference filtering threshold. The processor 1 may set the filtering threshold to be gradually decreased as the correlation coefficient becomes closer to 0.

Further, the processor 1 may set an average value of the intensity values identified from the sensing data as the reference filtering threshold. The processor 1 may set the filtering threshold to be greater than the reference filtering threshold when the correlation coefficient is equal to or greater than 0.5, and may set the filtering threshold to be smaller than the reference filtering threshold when the correlation coefficient is less than 0.5. In addition, the processor 1 may set the filtering threshold to be gradually increased with respect to the reference filtering threshold as the correlation coefficient becomes closer to 1, and may set the filtering threshold to be gradually decreased with respect to the reference filtering threshold as the correlation coefficient becomes closer to 0.

The processor 1 applies the filtering threshold dynamically set according to the correlation coefficient to the sensing data, and determines intensity values having values smaller than the filtering threshold as noise, thereby removing noise from the sensing data. The processor 1 may analyze the sensing data from which the noise has been removed to identify an object and the like detected by the LiDAR sensor.

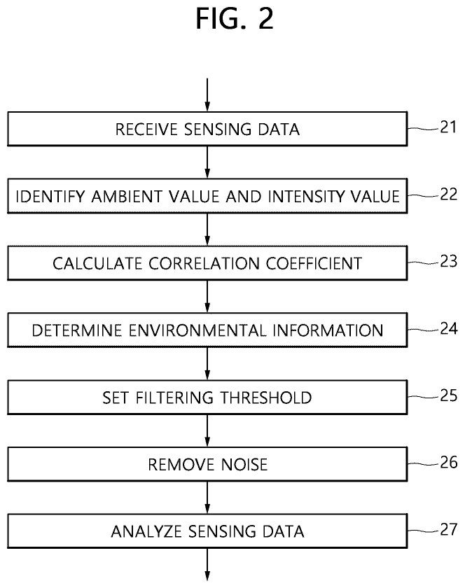

FIG. 2 is a flowchart for explaining a noise filtering method according to an exemplary embodiment of the present disclosure.

Referring to FIG. 2, the processor 1 receives sensing data acquired from a LiDAR sensor included in the input/output device 7 (21). The processor 1 identifies an intensity value and an ambient value from the received sensing data (22).

More specifically, the processor 1 identifies a wavelength of emitted light irradiated from the LiDAR sensor. The processor 1 identifies, as an intensity value, data having a wavelength corresponding to the wavelength of the emitted light from the sensing data. The processor 1 identifies, as an ambient value, data having a wavelength other than the wavelength of the emitted light from the sensing data.

The processor 1 calculates a correlation coefficient between 0 and 1 using Equation 1 below based on the identified intensity value and ambient value (23). The processor 1 determines environmental information of a location where the LiDAR sensor is located based on the calculated correlation coefficient (24).

$${r}_{A , l} = \frac{Cov ( A , I )}{{σ}_{A} {σ}_{I}} \qquad [ Equation 1 ]$$

Where, r_{A,I} denotes a correlation coefficient calculated from an ambient value (A) and an intensity value (I), σ_{A}σ_{I} denotes a standard deviation of the ambient value (A) and the intensity value (I), and Cov(A, I) denotes a covariance of the ambient value (A) and the intensity value (I).

The processor 1 may determine environmental information to indicate that an environment is an outdoor or daytime environment when the calculated correlation coefficient is close to 1, and may determine the environmental information to indicate that the environment is an indoor or nighttime environment when the correlation coefficient is close to 0.

The processor 1 sets a filtering threshold for removing noise from the sensing data (25). More specifically, when the calculated correlation coefficient is equal to or greater than 0.5, the processor 1 may set the filtering threshold to be greater than a reference filtering threshold, and may set the filtering threshold to be gradually increased as the correlation coefficient becomes closer to 1.

In addition, when the calculated correlation coefficient is less than 0.5, the processor 1 may set the filtering threshold to be equal to the reference filtering threshold or set the filtering threshold to be smaller than the reference filtering threshold. The processor 1 may set the filtering threshold to be gradually decreased as the correlation coefficient becomes closer to 0. In this case, the reference filtering threshold may be a value preset based on the LiDAR sensor.

Further, the processor 1 may set an average value of the intensity values identified from the sensing data as the reference filtering threshold. The processor 1 may set the filtering threshold to be greater than the reference filtering threshold when the correlation coefficient is equal to or greater than 0.5, and may set the filtering threshold to be smaller than the reference filtering threshold when the correlation coefficient is less than 0.5. In addition, the processor 1 may set the filtering threshold to be gradually increased with respect to the reference filtering threshold as the correlation coefficient becomes closer to 1, and may set the filtering threshold to be gradually decreased with respect to the reference filtering threshold as the correlation coefficient becomes closer to 0.

The processor 1 applies the filtering threshold dynamically set according to the correlation coefficient to the sensing data, and determines intensity values having values smaller than the filtering threshold as noise, thereby removing noise from the sensing data (26). The processor 1 may analyze the sensing data from which the noise has been removed (27) to identify an object and the like detected by the LiDAR sensor.

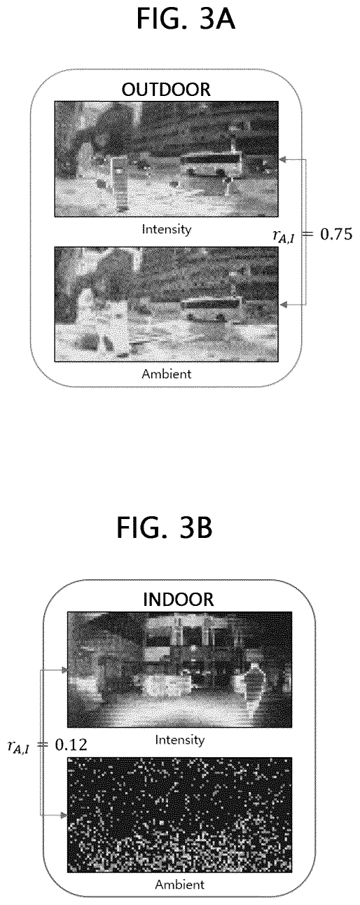

FIGS. 3A and 3B are exemplary screen views for explaining a method of classifying an environment using a correlation coefficient according to an exemplary embodiment of the present disclosure.

Referring to FIG. 3, FIGS. 3A and 3B illustrate intensity values and ambient values identified based on sensing data acquired by a LiDAR sensor in different environments. The processor 1 calculates a standard deviation and a covariance of the intensity values and the ambient values of FIGS. 3A and 3B, and calculates a correlation coefficient based on Equation 1.

As a result of the calculation, the processor 1 may identify that the correlation coefficient is calculated to be 0.75 in the case of FIG. 3A and is calculated to be 0.12 in the case of FIG. 3B. Accordingly, since the correlation coefficient of FIG. 3A is 0.75, which is equal to or greater than 0.5, the processor 1 may determine that an environmental condition of the LiDAR sensor is an outdoor environment or that a time point at which the LiDAR sensor acquires the sensing data is a daytime time. In addition, since the correlation coefficient of FIG. 3B is 0.12, which is less than 0.5, the processor 1 may determine that the environmental condition of the LiDAR sensor is an indoor environment or that the time point at which the LiDAR sensor acquires the sensing data is a nighttime time.

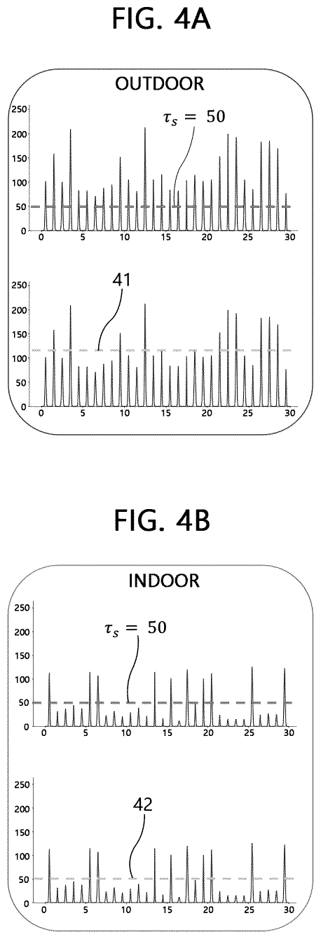

FIGS. 4A and 4B are exemplary screen views for explaining a method of dynamically setting a filtering threshold according to a classified environment according to an exemplary embodiment of the present disclosure.

Referring to FIG. 4, FIGS. 4A and 4B may be graphs corresponding to FIGS. 3A and 3B, respectively, and may be graphs illustrating intensity values of sensing data received at a specific time point by the LiDAR sensor. An x-axis of each graph may represent time, and a y-axis may represent an intensity value.

The processor 1 may identify, as shown in FIGS. 4A and 4B, that a reference filtering threshold τₛ is 50. The processor 1 identifies that the correlation coefficient calculated in the environment of FIG. 3A is 0.75 and that the correlation coefficient calculated in the environment of FIG. 3B is 0.12.

Accordingly, the processor 1 may increase a filtering threshold 41 to 120 based on the environmental information of FIG. 3A, and may maintain a filtering threshold 42 at 50 based on the environmental information of FIG. 3B. In addition, although FIG. 4B illustrates, by way of example, that the filtering threshold 42 is set to be equal to the reference filtering threshold τₛ, the present disclosure is not necessarily limited thereto, and the filtering threshold 42 may be set to be smaller than the reference filtering threshold τₛ.

The processor 1, after setting the filtering thresholds 41 and 42, determines intensity values smaller than the filtering thresholds 41 and 42 as noise and removes the noise from the sensing data, and may identify an object detected by the LiDAR sensor using remaining intensity values.

As described above, according to the present disclosure, a filtering threshold is dynamically set based on environmental information at a time point at which sensing data is acquired by a LiDAR sensor, thereby effectively removing noise that may be generated according to the environmental information and improving reliability of the data.

In addition, the processor 1 may apply the modified filtering threshold and acquire surrounding information based on sensing data from which noise has been removed, and may apply the acquired surrounding information to vehicle control such as autonomous driving.

Further, the processor 1 may dynamically (periodically or aperiodically) change the filtering threshold by calculating a correlation coefficient between intensity and ambient of the sensing data periodically or aperiodically even during driving and comparing the calculated correlation coefficient with a threshold.

While the present disclosure has been described in detail with reference to representative embodiments, it will be understood by those skilled in the art that various modifications and equivalent other embodiments may be possible based on the present disclosure. Accordingly, the true technical scope of the present disclosure should be defined by the spirit of the appended claims.

What is claimed is:

1. An apparatus comprising:
one or more processors; and
a memory storing one or more programs executable by the one or more processors,
wherein the one or more processors are configured to:
determine environmental information of a location in which a LiDAR sensor is located using sensing data acquired from the LiDAR sensor; and
change a filtering threshold for removing noise from the sensing data based on the environmental information.

2. The apparatus of claim 1, wherein the one or more processors are configured to determine an intensity value and an ambient value from the sensing data.

3. The apparatus of claim 2, wherein the one or more processors are configured to determine the intensity value from the sensing data based on a wavelength of emitted light irradiated from the LiDAR sensor.

4. The apparatus of claim 3, wherein the one or more processors are configured to determine the ambient value from the sensing data based on a wavelength of light other than the wavelength of the emitted light.

5. The apparatus of claim 4, wherein the one or more processors are configured to determine a correlation coefficient between 0 and 1 based on the intensity value and the ambient value, and determine the environmental information based on the correlation coefficient.

6. The apparatus of claim 5, wherein the one or more processors are configured to set the filtering threshold to be greater than a reference filtering threshold when the correlation coefficient is equal to or greater than 0.5.

7. The apparatus of claim 6, wherein the one or more processors are configured to set the filtering threshold to be gradually increased as the correlation coefficient becomes closer to 1.

8. The apparatus of claim 5, wherein the one or more processors are configured to set the filtering threshold to be equal to or smaller than the reference filtering threshold when the correlation coefficient is less than 0.5.

9. The apparatus of claim 8, wherein the one or more processors are configured to set the filtering threshold to be gradually decreased as the correlation coefficient becomes closer to 0.

10. The apparatus of claim 5, wherein the one or more processors are configured to remove the noise by deleting intensity values that are less than the dynamically set filtering threshold from the sensing data.

11. A method performed by an apparatus comprising one or more processors and a memory storing one or more programs executable by the one or more processors, the method comprising:
determining environmental information of a location in which a LiDAR sensor is located using sensing data acquired from the LiDAR sensor; and
changing a filtering threshold for removing noise from the sensing data based on the environmental information.

12. The method of claim 11, further comprising determining an intensity value and an ambient value from the sensing data.

13. The method of claim 12, wherein the step of determining the intensity value comprises determining the intensity value from the sensing data based on a wavelength of emitted light irradiated from the LiDAR sensor.

14. The method of claim 13, wherein the step of determining the ambient value comprises determining the ambient value from the sensing data based on a wavelength of light other than the wavelength of the emitted light.

15. The method of claim 14, wherein the step of determining the environmental information comprises determining a correlation coefficient between 0 and 1 based on the intensity value and the ambient value, and determining the environmental information based on the correlation coefficient.

16. The method of claim 15, further comprising setting the filtering threshold to be greater than a reference filtering threshold when the correlation coefficient is equal to or greater than 0.5.

17. The method of claim 16, wherein the step of setting the filtering threshold to be greater than the reference filtering threshold comprises setting the filtering threshold to be gradually increased as the correlation coefficient becomes closer to 1.

18. The method of claim 15, further comprising setting the filtering threshold to be smaller than a reference filtering threshold when the correlation coefficient is less than 0.5.

19. The method of claim 18, wherein the step of setting the filtering threshold to be smaller than the reference filtering threshold comprises setting the filtering threshold to be gradually decreased as the correlation coefficient becomes closer to 0.

20. The method of claim 15, further comprising removing the noise by deleting intensity values that are less than the dynamically set filtering threshold from the sensing data.
